(19) United States
(12) Patent Application Publication
(10) Pub. No.: US 2025/0156460 A1
(43) Pub. Date: May 15, 2025

(54) SYSTEMS AND METHODS FOR GENERATING A WORKFLOW DATA STRUCTURE

(71) Applicant: A&E Engineering, Inc., Greer, SC (US)

(72) Inventors: Micaela Gibson, Greer, SC (US); Lauren Challe Matthews, Boise, ID (US); Pamela Sellers, Boise, ID (US); Edgar Jimenez, Concord, NC (US); Calvin Mark Hamus, Stevens Point, WI (US); Christopher Michael Gibson, Greer, SC (US)

(21) Appl. No.: 18/941,807

(22) Filed: Nov. 8, 2024

Related U.S. Application Data
(60) Provisional application No. 63/597,911, filed on Nov. 10, 2023.

(51) Int. Cl. G06F 16/33; G06F 16/35; G06F 40/30

(52) U.S. Cl. CPC G06F 16/3344; G06F 16/35; G06F 40/30

(57) ABSTRACT

Systems and methods for generating a workflow data structure are provided. The system includes one or more processors; and one or more transitory or non-transitory computer-readable media storing instructions that are executable to cause the one or more processors to perform operations, the operations comprising: receiving input data comprising a corpus of documents, a user query, and query context data; processing the corpus of documents to generate training data; training a large language model (LLM) using the training data; classifying, using the LLM, the user query to at least one content cluster of a plurality of content clusters based on the query context data; constructing, using the LLM, a workflow data structure as a function of the classifying; and generating, using the LLM, a query response as a function of the user query, the query context data, and the workflow data structure.

### CROSS-REFERENCE TO RELATED APPLICATIONS

The present application claims priority to U.S. Provisional Patent Application No. 63/597,911, filed on Nov. 10, 2023, the disclosure of which is incorporated by reference herein in its entirety.

### FIELD

The present disclosure relates generally to systems and methods for generating a workflow data structure.

### BACKGROUND

The loss of institutional knowledge has been an ongoing and persistent challenge for organizations. Attempts to store this knowledge in databases and other computing systems often lead to cumbersome and laborious data retrieval processes. Once the data is retrieved from the computing systems, the users often encounter difficulties in identifying the correct solution that will be applicable to their current issues. This disconnect highlights the need for more dynamic and responsive data structures that can not only aggregate institutional knowledge effectively but also tailor responses to specific user queries and contexts.

### BRIEF DESCRIPTION

Aspects and advantages of the invention in accordance with the present disclosure will be set forth in part in the following description, or can be obvious from the description, or can be learned through the practice of the technology.

One example aspect of the present disclosure is directed to a computing system. The computing system includes one or more processors and one or more tangible, non-transitory, computer readable media that store instructions that are executable by the one or more processors to cause the computing system to perform operations. The operations include receiving input data comprising a user query and query context data; classifying, using a large language model (LLM), the user query to at least one content cluster of a plurality of content clusters based on the query context data; constructing, using the LLM, a workflow data structure as a function of the classifying; and generating, using the LLM, a query response as a function of the user query, the query context data, and the workflow data structure.

Another Example aspect of the present disclosure is directed to a computer-implemented method. The method includes receiving, by one or more processors, input data comprising a corpus of documents, a user query, and query context data; processing, by the one or more processors, the corpus of documents to generate training data; training a large language model (LLM) using the training data; classifying, using the LLM operating on the one or more processors, the user query to at least one content cluster of a plurality of content clusters based on the query context data; constructing, using the LLM, a workflow data structure as a function of the classifying; and generating, using the LLM, a query response as a function of the user query, the query context data, and the workflow data structure.

Another example aspect of the present disclosure is direct to a computing system. The computing system includes one or more processors and one or more tangible, non-transitory, computer readable media that store instructions that are executable by the one or more processors to cause the computing system to perform operations. The operations include receiving input data comprising a corpus of documents; processing the corpus of documents to generate training data, wherein processing the corpus of documents comprises: segmenting the corpus of documents into a plurality of segments based on a semantic pattern; and producing one or more embeddings for each segment of the plurality of segments; and generating the training data based on the one or more embeddings; and training a large language model (LLM) using the training data.

Another example aspect of the present disclosure is directed to one or more non-transitory computer readable media storing instructions that are executable by one or more processors to perform operations. The operations include receiving input data comprising a user query and query context data; classifying, using a large language model (LLM), the user query to at least one content cluster of a plurality of content clusters based on the query context data; constructing, using the LLM, a workflow data structure as a function of the classifying; and generating, using the LLM, a query response as a function of the user query, the query context data, and the workflow data structure.

Yet another example aspect of the present disclosure is directed to one or more non-transitory computer readable media storing instructions that are executable by one or more processors to perform operations. The operations include receiving, by one or more processors, input data comprising a corpus of documents, a user query, and query context data; processing, by the one or more processors, the corpus of documents to generate training data; training a large language model (LLM) using the training data; classifying, using the LLM operating on the one or more processors, the user query to at least one content cluster of a plurality of content clusters based on the query context data; constructing, using the LLM, a workflow data structure as a function of the classifying; and generating, using the LLM, a query response as a function of the user query, the query context data, and the workflow data structure.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 depicts an exemplary block diagram for a system for generating a workflow data structure in accordance with embodiments of the present disclosure;

FIG. 2 depicts an exemplary block diagram of a system for the generation of training data from a corpus of documents in accordance with embodiments of the present disclosure;

FIG. 3 depicts an exemplary embodiment of a workflow data structure in accordance with embodiments of the present disclosure;

FIG. 4 depicts an illustration of an exemplary embodiment of a chatbot;

FIG. 5 depicts an exemplary flow diagram for a method for generating a workflow data structure in accordance with embodiments of the present disclosure; and

FIG. 6 depicts an example computing system according to example embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” can be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. As such the use of “or” can include “and/or.” For example, a condition A or B is satisfied by any one of the following: A is true (or present), and B is false (or not present), A is false (or not present), and B is true (or present), and both A and B are true (or present).

As used herein “as a function of” can mean “based on” or “based at least in part on.” As such, “as a function of” is meant to encompass any utilization of a following term in a computation or operation performed by the system.

Benefits, other advantages, and solutions to problems are described below with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Generally, the present disclosure outlines systems and methods for creating a workflow data structure. This process begins by receiving a corpus of documents related to a specific entity, such as service manuals or operational guidelines. The system employs one or more embedding models to segment each document. These segments are analyzed using natural language processing techniques to produce vectors that encapsulate their semantic meanings.

Once the vectors are generated, the system constructs a unique training set derived from the corpus of documents. This training set can be used for fine-tuning a Large Language Model (LLM) or an equivalent generative model. The training process is iterative, meaning it continues until the LLM surpasses an accuracy threshold. This can be done to ensure that the LLM is trained on the relationships and nuances present in the original corpus of documents.

The system may classify the user queries into specific content clusters derived from the previously created training set. By linking user queries to the appropriate clusters, the system can streamline the response generation process. This classification can allow the LLM to identify which content is most relevant to the user's query in an efficient manner.

The system generates a workflow data structure to store these content clusters and the correlations between user queries and their corresponding responses. This structure serves as a repository of information that the LLM can reference when generating responses. In some cases, the LLM may employ a Retrieval-Augmented Generation (RAG) architecture when generating the query responses. When the LLM accesses the workflow data structure, it may employ RAG to retrieve relevant correlations between user inquiries and previous responses. Using this, the LLM can reference a curated set of information that directly addresses the user query. This allows the model to generate contextually relevant query responses that are grounded in corpus of documents.

With reference now to the Figures, example embodiments of the present disclosure will be discussed in further detail.

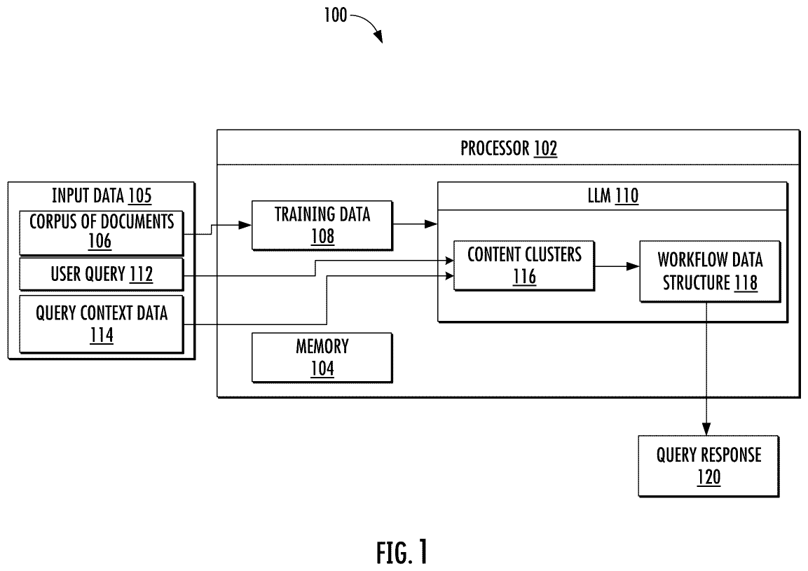

Referring now to FIG. 1, an exemplary embodiment of a system for generating a workflow data structure. System 100 includes a processor 102, memory 104, corpus of documents 106, training data 108, large language model (LLM) 110, user query 112, query context data 114, content clusters 116, workflow data structure 118, query response 120, and the like.

FIG. 1 depicts a block diagram of an exemplary system 100 for generating a workflow data structure. System 100 includes one or more processors 102 that can be utilized to perform one or more operations. The one or more processors 102 can include any suitable processing device (e.g., a processor core, a microprocessor, an ASIC, a FPGA, a controller, a microcontroller, etc.) and can be one processor or a plurality of processors that are operatively connected. The one or more processors 102 can perform operations in series or in parallel. The one or more processors 102 can be dedicated to a particular computing device or can be utilized by a plurality of devices to perform processing tasks. One or more of these computing devices can be employed to handle specific processing tasks and operations.

Processor 102 can be designed or configured to perform any method, method step, or sequence of method steps in any embodiment described in this disclosure, in any order and with any degree of repetition. For instance, processor 102 can be configured to perform a single step or sequence repeatedly until a desired or commanded outcome is achieved. Repetition of a step or a sequence of steps can be performed iteratively or recursively using outputs of previous repetitions as inputs to subsequent repetitions, aggregating inputs or outputs of repetitions to produce an aggregate result, reduction or decrement of one or more variables such as global variables, or division of a larger processing task into a set of iteratively addressed smaller processing tasks. This can be used to train, refine, or otherwise improve any algorithm, image processing model, machine-learning model, neural network, and the like mentioned herein.

Processor 102 can include a single computing device operating independently, or can include two or more computing devices operating in concert, in parallel, sequentially or the like. Two or more computing devices can be included together in a single computing device or in two or more computing devices. Processor 102 can include but is not limited to, for example, a computing device or cluster of computing devices in a first location and a second computing device or cluster of computing devices in a second location. Processor 102 can include one or more computing devices dedicated to data storage, security, distribution of traffic for load balancing, and the like. Processor 102 can distribute one or more operations as described below across a plurality of computing devices, which can operate in parallel, in series, redundantly, or in any other manner used for distribution of tasks or memory between computing devices.

System 100 can include memory 104 which can store data or instructions. Memory 104 can include one or more non-transitory computer-readable storage mediums, such as RAM, ROM, EEPROM, EPROM, flash memory devices, magnetic disks, etc., and combinations thereof. The data can include user data, application data, operating system data, etc. The data can include text data, image data, audio data, statistical data, latent encoding data, etc. The instructions can include instructions that when executed by one or more of the processors 102 can cause system 100 to perform operations as described herein.

Memory 104 can store data or instructions associated with one or more applications. The one or more applications can include native, factory-set applications or downloaded applications. The applications can include one or more messaging applications, one or more image capture applications, one or more productivity applications, one or more map applications, one or more device management applications, one or more browser applications, and the like. In some implementations, the applications can include one or more applications communicatively connected to one or more server computing systems for providing access to a platform. For example, the applications can include an application for generating a workflow data structure.

Generally, systems and methods for generating a workflow data structure are disclosed. The workflow data structure can be an organized framework that captures, stores, and manages information related to various tasks and problem-solving procedures. The workflow data structure can be created from a large corpus of documents that have been received from an entity. This can be done by using a large language model or an equivalent generative model to process and organize the corpus of documents into the workflow data structure. Once the workflow data structure has been created, systems and methods disclosed herein can query the workflow data structure using user queries and query context data. The large language model can then be used to generate a query response based on the user query, the query context data, and the workflow data structure.

### Processing a Corpus of Documents to Generate Training Data for the LLM

System 100 can include a processor 102 that receives input data 105 that includes a corpus of documents 106. A corpus of documents 106 can include a structured collection of written texts. The corpus of documents 106 can include a variety of text types, such as entity documents, business documents, inventory documentation, emails, maintenance reports, repair reports, instruction manuals, user communications, academic articles, literary works, newspapers, social media posts, advertising documents, newspaper articles, and the like.

In some implementations, the corpus of documents can include documentation that is related to a specific entity. The corpus of documents can contain information related to the business dealings of the entity. Business dealings can include, for example, financial statements, meeting minutes, strategic reports, business plans and proposals, regulatory filings, market research, employee handbooks, internal policies, or any documentation associated with the entity.

The corpus of documents 106 can be accessed via automated or manual means. For instance, the corpus of documents 106 can be received from a database, API, web crawler, and the like. In cases where documents are not readily accessible through automated means, the system 100 can facilitate manual uploads of the corpus of documents 106.

The corpus of documents 106 can be received, by processor 102, from a database. This can include receiving the corpus of documents 106 from a centralized database associated with the entity. In an embodiment, system 100 can gather the corpus of documents 106 by executing structured queries to extract relevant documents based on specific criteria, such as date ranges or document types. In a non-limiting example, system 100 can query the database for all quarterly maintenance reports for a mechanical system from the past five years, compiling these documents into the corpus of documents 106.

The corpus of documents 106 can be received, by processor 102, from an application program interface (API). APIs can be used to facilitate the exchange of data between systems. System 100 can send a request to the API, specifying the desired documents. Upon receiving a response, processor 102 can process the incoming data stream, extracting relevant documents from the API and adding them directly to the corpus of documents 106.

In an embodiment, system 100 can employ one or more web scraping techniques to gather the corpus of documents 106 from websites or online repositories. System 100 can employ a web crawler to navigate web pages and identify specific content. A web crawler is an automated tool designed to systematically browse the internet and collect information from web pages. When used to gather a corpus of documents 106, the web crawler can be configured to scrape through specified websites, following hyperlinks to discover and download relevant content. The web crawler can be configured to extract data such as text, images, and metadata from pages that meet predefined criteria, such as document type or keyword relevance. In a non-limiting example, a web crawler can be configured to target a list of pre-determined websites to gather the corpus of documents 106, such as regulatory sites, websites associated with the entity, entity databases, academic databases, or industry news platforms. Once the desired data is retrieved, the web crawler organizes and formats the documents for integration into the corpus of documents 106.

With continued reference to FIG. 1, the operations can include processing the corpus of documents 106 to generate training data 108. As used in the current disclosure, training data 108 is data containing correlations that a machine-learning process can use to model relationships between two or more categories of data elements. Training data can include a number of data entries, also known as training examples, each entry representing a set of data elements that were recorded, received, or generated together. Data elements can be correlated by shared existence in each data entry, by proximity in a given data entry, or the like. In a non-limiting example, training examples can include examples of user queries or embeddings correlated to examples of content clusters. Additionally, training examples can include examples of entries within the workflow data structure 118 correlated to examples of query responses. The relationship between two or more data entries can be used to evidence one or more trends in correlations between categories of data elements. Multiple categories of data elements can be related in training data 108 according to various correlations. Correlations can indicate causative or predictive links between categories of data elements, which can be modeled as relationships such as mathematical relationships by machine-learning processes as described in further detail below.

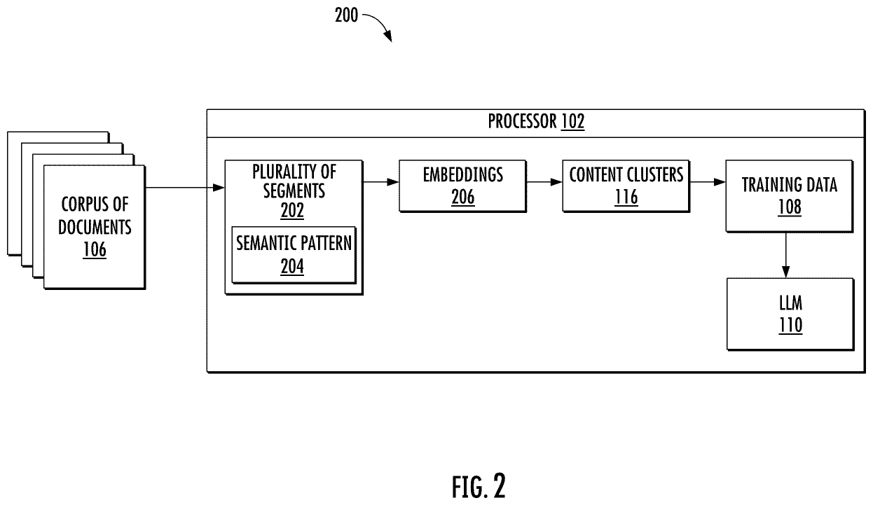

Referring now to FIG. 2, an exemplary block diagram of a system for the generation of training data from a corpus of documents. FIG. 2 includes a plurality of segments 202, a semantic pattern 204, embeddings 206, and the like.

The corpus of documents 106 can be processed to generate training data 108. Processing the corpus of documents 106 can include segmenting the corpus of documents 106 into a plurality of segments 202 based on a semantic pattern 204. As used in the current disclosure, semantic patterns refer to a recognizable structure or relationship that captures the meaning and context of specific segments within a document. The semantic pattern 204 of a segment 202 can be detected through various natural language processing techniques, such as clustering algorithms, topic modeling, or keyword extraction. By applying these methods, the documents can be categorized into meaningful segments that encapsulate distinct ideas or narratives.

Identifying semantic patterns 204 within the corpus of documents 106 can be used to organize the content of the documents. System 200 can apply natural language processing (NLP) techniques to identify the semantic patterns 204 within the corpus of documents. This can include parsing the documents to identify and extract keywords and phrases that frequently co-occur in text segments. By focusing on these co-occurrences, the system 200 can gain insights into which terms are most relevant to the themes present in the documents.

To facilitate this keyword extraction, system 100 can implement NLP techniques such as term frequency-inverse document frequency (TF-IDF). TF-IDF is a statistical measure that evaluates how important a word is to a document in a collection or corpus. By calculating the frequency of each term relative to its occurrence in other documents, TF-IDF helps to highlight keywords that are particularly significant for a document. For instance, if terms like “renewable energy,” “climate policy,” and “sustainable development” rank highly in TF-IDF scores, they can indicate that these concepts are central to the themes explored within the document. This quantitative analysis enables the system to pinpoint core themes that can warrant further exploration.

To get a more holistic view of the dataset, TF-IDF can include an evaluation of synonyms and related terms. In an embodiment, system 100 can generate embeddings for the terms within the document. The embeddings for the keywords can be evaluated and compared to the embedding of similar or related terms. Based on the level of similarity of the embeddings, synonyms and related terms can be accounted for in the TF-IDF. In an embodiment, models such as Word2Vec or GloVe can be used to assist the processor 102 to capture semantic relationships between words. For instance, if the embedding for the term “Machine A” is positioned closely to an embedding for the terms “Water Pump” and “Axial Flow Pump” the processor 102 can infer that these terms can be discussing the same or similar pieces of equipment.

In an embodiment, system 100 can apply one or more clustering techniques to group related keywords based on their contextual relationships. Clustering algorithms, such as k-means or hierarchical clustering, can be used to organize these keywords into thematic clusters. For example, if “System A,” “Machine B,” and “Part 1” frequently appear together, they can form a cohesive cluster indicating a segment focused on a mechanical system and the machines that make up that mechanical system. Conversely, if terms like “Budget,” “Cost,” and “Finances” often co-occur, they might signal a segment dedicated to discussions about the finances of running and operating System A. This grouping allows for a more nuanced understanding of how different topics interrelate within the corpus.

Once the clusters are established, they can be mapped to specific sections within a document within the corpus of documents 106. The processor 102 analyzes the text, identifying segments that include high concentrations of keywords from each cluster. For instance, paragraphs discussing system A would likely align with the “Mechanical Systems” cluster, while sections focused on financial policy could align with the “Financial Policy” cluster. The identified clusters can serve as guides for dividing the document into meaningful sections based on topic.

With the clusters mapped to specific documents within the corpus of documents 106, the processor 102 can define segment boundaries based on the presence of keywords and their relationships. By applying algorithms that recognize topic shifts, the system can delineate where one segment ends and another begins. This can include evaluating changes in keyword frequency or the emergence of new clusters. This might involve setting thresholds for keyword density or identifying transitions in the narrative flow of the document.

To define segment boundaries within the corpus of documents 106, one or more algorithms can be used to effectively recognize semantic patterns 204 through a combination of keyword analysis and semantic clustering. This can include evaluating changes in keyword frequency or the emergence of new clusters. Defining segment boundaries can include setting thresholds for keyword density or identifying transitions in the narrative flow of the document.

In an embodiment, system 200 can define segment boundaries based on keyword frequency changes. As the text progresses, certain keywords associated with specific themes can rise or fall in prominence. For example, if a document starts with a focus on engineering topics but later shifts to discuss regulatory and budget topics, a sudden change in the frequency of keywords can signal a topic shift. The algorithm can be designed to calculate the frequency of keywords within defined text windows, such as paragraphs or sentences. This allows the algorithm to detect when a frequency of a term surpasses a set threshold. When the frequency of keywords from one cluster begins to decline significantly while those from another cluster start to rise, this provides an indication of where to establish segment boundaries.

In addition to tracking keyword frequency, the algorithms can set specific thresholds for keyword density to further refine the segmentation process. By determining a minimum percentage of relevant keywords that must be present for a segment to retain its semantic integrity, the system ensures that each segment is cohesively focused on a single topic. For example, if a segment is primarily about an engineering process the algorithm might require that at least 30% of the words in that segment are from a predefined set of keywords related to that engineering process. If this threshold is not met, the algorithm can indicate that a boundary should be placed to separate it from the next segment, which can better align with another cluster.

In some cases, the algorithms that are used to identify the plurality of segments 202 based on a semantic pattern 204 can include machine-learning models. These machine-learning models can be trained using annotated training data. The annotated training data can include examples of segments that have labeled segment boundaries. Based on this annotated training data, the algorithms, and machine-learning models can learn from patterns and contextual clues that cannot be immediately apparent through keyword analysis alone. Training the machine-learning model can be done in any manner that is described throughout this disclosure.

With continued reference to FIG. 2, processing the corpus of documents 106 can include producing one or more embeddings 206 for each segment of the plurality of segments 202. Embeddings are mathematical representations of words or phrases in a continuous vector space where semantically similar items are located closer together. With respect to the plurality of segments 202, the plurality of embeddings 206 can be used to represent textual data using vectors. These embeddings 206 are configured to capture the semantic meanings and relationships between words within each segment. For instance, two segments discussing a maintenance procedure for a piece of equipment might generate embeddings that are closely aligned in the vector space, while segments on unrelated topics would be positioned farther apart. The spatial relationship between the embeddings can be used to generate training data for the LLM.

Producing one or more embeddings 206 can include tokenizing each segment of the plurality of segments 202. This can include tokenizing the plurality of segments 202 by breaking down the segments into individual components, such as words, phrases, sub-words, and key terms. Tokenizing each segment of the plurality of segments 202 can include normalizing the text of each segment 202. Normalization can include converting all text to lowercase to avoid case sensitivity issues, removing unnecessary whitespace, and handling special characters. In some cases, special entries, such as URLs or email addresses, can be tokenized as a single token.

Once the text of each segment 202 is normalized, the system 200 can effectively employ tokenization algorithms. These algorithms utilize both natural language processing (NLP) libraries and string manipulation techniques to break down the text into its constituent parts. In a non-limiting example, the algorithm can traverse each segment character by character, generating a new token whenever it encounters a space or punctuation mark. This approach can allow for the tokenization of individual words and phrases. In some cases, the tokenization algorithms can leverage machine-learning techniques to enhance their accuracy and effectiveness.

The processor 102 can generate one or more embeddings 206 for each segment of the plurality of segments 202 from the tokenized text. This will allow for the transformation of the textual data of the plurality of segments 202 into a numerical format that can be utilized by machine-learning models or other computer-based processes. Based on the tokenized text, the processor 102 can select a method for generating the embedding. These methods can include, but are not limited to, Word2Vec, Global Vectors for Word Representation (GloVe), transformer-based models (i.e., BERT and GPT), and similar approaches.

After selecting the embedding method, the processor 102 will proceed to convert the tokenized text into a suitable numerical representation, leveraging the chosen technique to capture the semantic relationships among the tokens. In a non-limiting example, if Word2Vec is selected, the processor will utilize the surrounding context of each token to create vectors that reflect their meanings based on co-occurrence patterns. If a transformer-based model is used, the processor will generate contextual embeddings that adapt to the specific usage of each token within its segment, thereby providing a more nuanced representation. The resulting embeddings 206 will enable the system to effectively analyze and process the textual data. This will facilitate data processing tasks such as classification, clustering, or semantic analysis.

With continued reference to FIG. 2, the operations can further include generating the training data 108 based on the one or more embeddings 206. As used in the current disclosure, training data 108 refers to a dataset used to train a machine-learning model, LLM, or another algorithm. Training data 108 consists of input-output pairs where the input data is the features derived from raw data (i.e. embeddings 206), and the output is the corresponding label or target value (i.e. query response 120) that the model aims to predict. The training data 108 can consist of a structured dataset derived from embeddings 206 that defines the relationships between categories of data elements. This training data 108 includes multiple entries, each entry representing a collection of embeddings that have been generated from tokenized text. These embeddings reflect the semantic content of the original text segments (i.e. corpus of documents 106). For instance, entries in training data 108 can reveal trends indicating that higher values in one category of embeddings tend to correlate with higher values in another, suggesting potential relationships that machine-learning models can exploit.

The training data 108 can include a plurality of data entries containing a plurality of inputs that are correlated to a plurality of outputs for training a processor by a machine-learning process. In an embodiment, training data can include exemplary user queries 112 correlated to exemplary query responses 120 or workflow data structure 118. In an embodiment, training data 108 can be iteratively updated as a function of the input and output results of past iterations of LLM 110 or other machine-learning models mentioned throughout this disclosure.

In an embodiment, the training data 108 can be organized according to the categories of data elements that are represented by the embeddings 206. This organization can involve labeling each embedding with descriptors that characterize its category. The relationships among the embeddings can be enhanced through the use of tags, tokens, or other metadata.

Additionally, training data 108 can include elements that are not explicitly categorized. In such cases, machine-learning algorithms can apply natural language processing techniques and correlation detection methods to sort and categorize these elements. For example, in a textual dataset, multi-word phrases can be statistically identified and categorized as new linguistic elements based on their frequency and co-occurrence. This flexibility enables the same training data 108 to be applicable across various machine-learning algorithms, enhancing its versatility.

Generating the training data 108 can include filtering, sorting, and selection processes for the training data 108. These processes can be implemented using both supervised and unsupervised machine-learning models. In some cases, a training data classifier can be utilized to categorize inputs based on established criteria, identifying clusters of similar data and associating them with relevant labels. This training data classifier can employ various algorithms, including linear classifiers, decision trees, and neural networks, to organize the training data 108 effectively.

In an embodiment, training examples for the training data 108 can be selected from a broader population based on relevant analytical needs. This selection process F be used to verify that the training data 108 captures a comprehensive range of scenarios the model can encounter. For each input category, the process can involve choosing representative examples across the spectrum of possible values, ensuring that the dataset reflects the statistical distribution of the underlying phenomena.

In some cases, the system 200 can implement a sanitization process to improve the quality of the training data 108. This involves identifying and removing outliers or poorly constructed examples that could skew the LLM's 110 learning process. Examples deemed to have low signal-to-noise ratios or that fall outside predefined thresholds can be eliminated to ensure the training data 108 contributes positively to model convergence and overall effectiveness.

### Training the Large Language Model Using the Training Data

With continued reference to FIG. 1, the operations can further include training the LLM 110 using the training data 108. As used in the current disclosure, a large language model can refer to a deep learning data structure that can recognize, summarize, translate, predict or generate text or other content. Large language models can be trained on large sets of data that include but are not limited to training data 108. In an embodiment, the LLM 110 can include one or more architectures based on the capability requirements of an LLM. Exemplary architectures can include, without limitation, GPT (Generative Pretrained Transformer), BERT (Bidirectional Encoder Representations from Transformers), T5 (Text-To-Text Transfer Transformer), and the like. Architecture choice can depend on a needed capability such as generative, contextual, or other specific capabilities. In an embodiment, the LLM 110 can be consistent with any machine-learning model described throughout this disclosure.

The inputs to the LLM 110 can include user queries 112, query context data 114, corpus of documents 106, smart prompts, and the like. Outputs to the LLM 110 can include workflow data structure 118 and query responses 120 tailored to the user queries 112 and query context data 114.

With continued reference to FIG. 1, the LLM 110 can be trained using training data 108 that is generated from embeddings 206, along with other training sets. Training the LLM 110 can include both general and specific training approaches. Generally training the LLM 110 refers to the initial phase where the model is exposed to a diverse training set that includes a wide array of subjects, datasets, and fields.

Following this general training, the LLM 110 can undergo specific training, which focuses on refining the model's capabilities using specialized training data 108 derived from the embeddings 206. This specific training is designed to enhance the LLM's 110 understanding of particular correlations and nuances relevant to its intended applications. For example, training data 108 can include user-specific information or data drawn from specific domains, allowing the model to learn from examples that reflect the targeted context it will operate in.

In an embodiment, training the LLM 110 with this training data 108 can be carried out using a supervised machine-learning process, where the model learns from input-output pairs. Conversely, the general training phase can employ an unsupervised approach, allowing the LLM 110 to learn patterns and structures in the data without explicit labels. Once the general training is complete, the model can be specifically trained on task-specific data that directly correlates with the desired outputs, adapting its performance to meet particular objectives.

The training process involves adjusting the model's parameters, specifically weights and biases, either randomly or by leveraging a pretrained model as a starting point. During the training phase, the LLM 110 learns to minimize a defined loss function, which quantifies the difference between its predicted outputs and the actual target values. Once the model is generally trained, specific training with the generated training data 108 fine-tunes its capabilities, ensuring that it can effectively address the specific tasks it is designed for.

Fine-tuning can include optimizing the model's performance by adjusting hyperparameters such as learning rate, batch size, and regularization techniques. This optimization process is used to facilitate the convergence of the LLM 110 during training. In an embodiment, fine-tuning the LLM 110 can employ Low-Rank Adaptation (LoRA), a technique that modifies a subset of the model's parameters. This approach improves computational efficiency by allowing targeted updates without the need to retrain the entire model from scratch. The parameters updated through LoRA can specifically relate to the tasks or domains relevant to the training data 108, enabling the LLM 110 to excel in its designated applications.

In an embodiment, system 200 can use user feedback to train the LLM 110. For example, the LLM 110 can be trained using past inputs and outputs of a previous iteration of the LLM 110. In some embodiments, if user feedback indicates that an output of LLM 110 was “bad” or “unfavorable,” then that output and the corresponding input can be removed from the training data, or can be replaced with a value entered by, e.g., another user that represents an ideal output given the input the LLM 110 originally received, permitting use in retraining, and adding to training data. In either case, LLM 110 can be retrained with modified training data as described throughout this disclosure.

In some embodiments, an accuracy score can be calculated for LLM 110 using user feedback. For the purposes of this disclosure, an accuracy score is a numerical value concerning the accuracy of the output of a machine-learning model. For example, the feedback from the user can be averaged to determine an accuracy score. The accuracy score can indicate a degree of retraining needed for a machine-learning model such as the LLM 110. Processor 102 can perform a larger number of retraining cycles for a higher number (or lower number, depending on a numerical interpretation used), or can collect more training data 108 for such retraining, perform more training cycles, apply a more stringent convergence test such as a test requiring a lower mean squared error, or indicate to a user or operator that additional training data is needed.

In some embodiments, the large language model 110 may include a retrieval-augmented Generation (RAG) framework. As used in the current disclosure, the Retrieval-Augmented Generation is designed to enhance the capabilities of traditional models by integrating information retrieval processes. In an embodiment, when a user query is submitted, the model may retrieve the relevant documents, segments, content clusters, and the like from the workforce data structure or similar data structure. Once relevant information is retrieved, the RAG model may input this contextual information into the LLM 110.

### Processing the User Query Based on the Query Context Data Using the Llm

With continued reference to FIG. 1, the operations include obtaining input data 105 including a user query 112. As used in the current disclosure, a user query 112 refers to a request for information made by a user, particularly regarding workplace tasks or issues. This user query 112 can act as a conduit for employees to seek guidance on a variety of topics, such as troubleshooting equipment, resolving system or process issues, understanding how the entity previously addressed similar problems, and identifying the most effective and efficient methods for handling specific challenges. User inquiries 112 can focus on mechanical and engineering problems encountered in the workplace.

In an embodiment, the user query 112 can be received from a user through various channels, such as online forms, customer service emails, live chat systems, chatbot systems 400, graphical user interfaces, and the like. Users can submit their user queries 112 by entering text, audio, images, or some combination of the three. In some cases, the user query 112 can include selecting options from a list that describes the requests or issues.

System 100 is configured to receive query context data 114 associated with the user query 112. Query context data 114 refers to the contextual information related to the user or the user query 112, providing additional insight into the circumstances surrounding the inquiry. This data can include information derived from the user's past interactions with the system 100.

Query context data 114 can include details about the user's previous interactions with the system 100. This includes previous searches conducted by the user, links clicked, pages visited, historical user inquiries and query responses, and other relevant actions exhibited within the system. In a non-limiting example, if a user has frequently searched for guidance related to a piece of equipment, the user's historical engagement can be captured as query context data 114. Analyzing these interactions, alongside the user's profile information, can allow the system to tailor its responses more precisely to the user query 112.

The query context data 114 can be generated by tracking and analyzing historical interactions with system 100, as well as evaluating the user profile data. When a user submits a new query, system 100 can leverage this contextual information to enhance its understanding of the user's current needs and preferences. For instance, if a user who has the job title of “Project Manager” and has previously sought information on the maintenance and repair of System A submits a query about how to repair Machine B, the system can infer that Machine B is likely a part of System A and tailor the response accordingly.

Additionally, query context data 114 can include a variety of information extracted from the user profile, including the user's name, identification number, job title, job description, assigned tasks, completed tasks, department, and other relevant details. The user profile can allow the system to understand the user's role within the organization and their specific responsibilities. By leveraging this information, the system can tailor responses to align with the user's context, ensuring that the guidance provided is not only relevant but also actionable. For instance, knowing the user's department and current tasks enables the system to suggest resources or solutions that are particularly suited to their unique challenges and objectives.

In an embodiment, the operations can further include processing the user query 112 and the query context data 114 to generate a smart prompt. As used in the current disclosure, the smart prompt is a specialized query designed to interact with the LLM 110. The smart prompt is generated to maximize the performance of the LLM 110 by using specific wording, structure, and contextual information. The smart prompt includes key details and context that can be used to guide the LLM 110 to provide a more refined answer. The smart prompt might provide additional information to the LLM 110 regarding which portion of the prompt to focus on, the length and format of the response, the key attributes, and the like.

In a non-limiting example, a user submits a user query 112 about “best practices for evaluating the life span of a piece of equipment.” System 100 can leverage the query context data 114 to generate a smart prompt that provides additional context and information to the LLM 110. The query context data 114 can include contextual information such as the user's job title, job responsibilities, and current and historical projects and tasks that the user is working on. Based on this additional context system 100 can generate a smart prompt that states “Given your role as a senior engineer who works with machine A, how would you evaluate the life span of machine A given the following performance metrics and maintenance history?” Through the use of this smart prompt, the LLM 110 can receive additional information about the user's specific context and also provides structured options for further inquiry.

With continued reference to FIG. 1, System 100 can be configured to update the query context data 114. This can be done in situations where the initial user query 112 lacks clarity or specificity. In such cases, the chatbot system 400 or system 100 can generate one or more contextual inquiries that are configured to elicit additional information from the user. These contextual inquiries can be formulated based on both the user query 112 and the existing query context data 114.

Contextual inquiries are configured to prompt the user to provide the necessary information that can have been overlooked or inadequately expressed in the initial query. For example, if a user submits a vague question about “issues with machinery,” the system might generate contextual inquiries such as “Which specific machine are you referring to?” or “Can you describe the symptoms of the issue you are experiencing?” These inquiries can be used to clarify the user's intent and provide more detailed information to the LLM 110. In an embodiment, the nature of these inquiries can vary based on the specific content of the user query and the existing query context data.

In some cases, the contextual inquiries can include questions regarding the actions the user has previously taken to address the problem. For example, if the initial user query 112 describes a process where the user is experiencing recurring issues with a specific piece of machinery, the system might ask, “What troubleshooting steps have you already attempted?” or “Have you made any recent changes to the machine's maintenance schedule?” Additionally, the contextual inquiries can include questions about the previous query response 120. For example, If the previous query response 120 has failed to resolve the issue, these contextual inquiries be used to identify additional context around the failure. This context can also be used to update the query context data with relevant historical information.

Once the user responds to these contextual inquiries, this response is referred to as the second user query. This new input allows the system to gather new details that were initially missing. For instance, if the user specifies a particular machine and describes its malfunction, the system can now update the query context data 114 to reflect this new information. After receiving the second user query, the system processes the new information and integrates it into the existing query context data 114. This integration might involve adjusting parameters within the user profile, such as adding details about the specific machinery or incorporating notes about the user's or entity's operational history with similar equipment.

With continued reference to FIG. 1, the operations further include classifying, by the LLM 110, the user query 112 to at least one content cluster of a plurality of content clusters 116 based on the query context data 114. As used in the current disclosure, the content clusters 116 refers to a group of related information, topics, or resources that share a common theme or subject matter. These content clusters 116 are structured representations of data that are used to represent a range of related materials. In an embodiment, each content cluster of the plurality of content clusters 116 can represent specific issues or areas of interest within an organization. For instance, one content cluster 116 can focus on “Maintenance of Equipment,” where the content cluster 116 includes resources about how to maintain and repair a piece of equipment. This can include repair protocols, best practices, policies, and the like. In another embodiment, another content cluster 116 might revolve around “Operational Procedures,” including information related to the operation of a piece of equipment.

The LLM 110 can be used to classify the user query 112 into at least one content cluster of a plurality of content clusters 116 based on the provided query context data 114. This classification process involves analyzing the keywords, intent, and contextual information associated with the user's query to effectively group similar user queries 112 and relevant information together. By leveraging the query context data 114, the LLM 110 can identify key themes and categorize the user queries 112 into the appropriate content cluster 116.

Moreover, by continuously analyzing incoming user queries 112 and their associated content clusters 116, the LLM 110 can iteratively adapt and refine the content clusters 116 over time, ensuring that they remain relevant and comprehensive as user queries 112 and other source materials for the content clusters 116 evolve.

In an embodiment, content clusters 116 can be enriched by the information sourced from the corpus of documents 106. Specific segments 202 of the corpus of documents 106 can be identified and associated with clusters 116 based on their relevance to the identified themes or subjects. These segments 202 can be mapped to specific content clusters 116 that directly address the topics discussed within the segment 202. For example, if a content cluster 116 is focused on “Safety Protocols,” segment 202 from the corpus of documents 106 might include safety guidelines, emergency procedures, and best practices extracted from relevant policy documents.

Linking the specific segments 202 of the corpus of documents 106 to content clusters 116 allows the LLM 110 to provide users with targeted responses that are grounded in authoritative sources that are specific to the entity. When a user submits a user query 112 that falls within a defined content cluster 116, the LLM 110 can identify relevant segments 202 to answer the inquiry comprehensively.

In some cases, as new documents are added to the corpus of documents 106 or existing documents are updated, segments 202 can be re-evaluated and re-assigned to a content cluster 116. This can be done to ensure that content clusters 116 remain relevant and accurate as the processes and procedures within the corpus of documents 106 are updated. The process of updating the content clusters 116 using new or revised data from the corpus of documents 106 or user queries 112 can be repeated iteratively until a predetermined threshold is met.

### Constructing a Workflow Data Structure as a Function of the Classifying

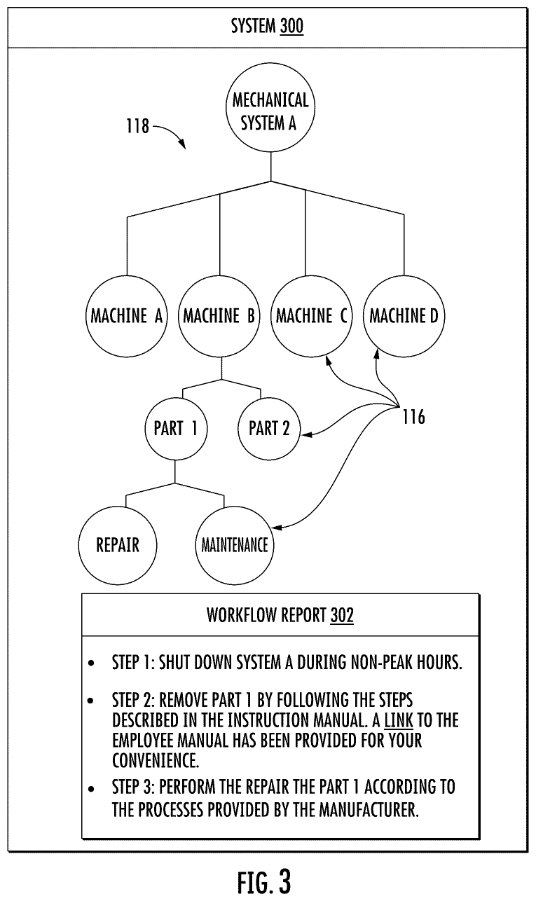

Referring now to FIG. 3, an exemplary embodiment of a workflow data structure. The operations further include constructing, using the LLM, a workflow data structure 118 as a function of the classification of the user queries 112 to content clusters 116. As used in the current disclosure, the workflow data structure 118 is a data structure designed to optimize the interaction between user queries 112 and content clusters 116. The workflow data structure 118 is configured to organize the content from the user queries 112 and the corpus of documents 106 to improve the LLM's 110 ability to generate relevant and contextually accurate responses. The workflow data structure 118 is configured to facilitate the retrieval and presentation of information.

The LLM 110 can label, tag, and organize the content clusters 116 with metadata. This labeling process provides structure to the content clusters 116. This structure is used to generate the workflow data structure 118. This labeling process can include enriching each content cluster 116 with tags that describe the content's relevance, context, and audience. This metadata can be continually updated based on changes and updates to the content clusters.

Additionally, the workflow data structure 118 incorporates relationship mappings to illustrate how different content clusters 116 are interconnected. By defining these relationships, the structure allows for more nuanced retrieval of information, enabling users to discover related content based on their initial queries.

The workflow data structure 118 is used to improve LLM's 110 efficiency in generating query responses 120. This can be done by the incorporation of predefined response templates tailored to specific content clusters 116. These templates can provide a framework for structuring replies, allowing the LLM 110 to quickly synthesize information and present it coherently while maintaining high-quality output.

With continued reference to FIG. 3, the workflow data structure 118 can include a workflow report 302. As used in the current disclosure, the workflow report 302 is a structured document generated from the workflow data structure 118. The workflow report 302 can be used to provide actionable responses to user queries 112 in a report format. This workflow report 302 can contain a comprehensive guide, outlining step-by-step instructions tailored to address specific user needs based on the user query 112 and the query context data 114.

Generating the workflow report 302 includes employing the LLM 110 to identify and retrieve relevant content clusters 116 based on historical user queries that are similar to the current user query 112. The LLM 110 then analyzes these clusters to extract pertinent information and compile it into a coherent report format.

Once the relevant data is gathered, the LLM organizes it into the predefined components of the workflow report. The step-by-step instructions are generated based on insights from the workflow data structure, allowing the report to reflect best practices and effective solutions that have been validated through user interactions.

### Generating a Query Response as a Function of the User Query, the Query Context Data, and the Workflow Data Structure

With continued reference to FIG. 1, the operations further include generating, using the LLM 110, a query response 120 as a function of the user query 112, the query context data 114, and the workflow data structure 118. As used in the current disclosure, the query response 120 is a structured answer generated in response to a user's inquiry or request for information. The query response 120 can incorporate relevant insights derived from query context data 114 and the workflow data structure 118. The query response 120 is designed to provide users with accurate, actionable, and contextually appropriate information tailored to their specific needs and circumstances. The query response 120 can be the output of a LLM or other machine-learning model. The query response 120 can take the form of a textual output, image data, or audio output. In some cases, the query response 120 can include step-by-step instructions related to an issue that was identified from the user query 112.

The LLM 110 can leverage the workflow data structure 118 to improve the quality of the query response 120. The use of the workflow data structure 118 allows the LLM 110 to contextualize the information associated with the user query 112 and the query context data 114. The workflow data structure enables the LLM 110 to produce tailored responses that outline clear steps or actions for the user to follow. When confronted with complex queries the LLM 110 can extract information related to historical processes and procedures of the entity from the workflow data structure 118.

The LLM 110 utilizes the workflow data structure 118 to tailor the query response 120 to the specific context of the instant user query 112. By analyzing the user query 112 in conjunction with the structured data of the workflow data structure 118, the LLM 110 can tailor its output to better fit the individual's needs. For instance, if a user has previously engaged with the system about a particular software application, the LLM 110 can reference information that is specific to that application, offering insights and solutions that are more relevant and tailored to the user's ongoing challenges. The LLM 110 can be configured to adjust the query response 120 based on various factors, such as prior interactions or the nuances of the current inquiry.

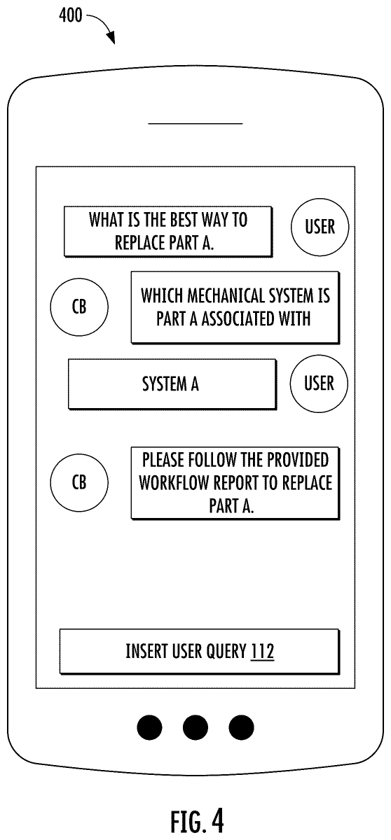

Referring now to FIG. 4, an illustration of an exemplary embodiment of a chatbot. The LLM 110 can generate the query responses 120 using chatbot 400. The chatbot system 400 can facilitate the interaction between users and the LLM 110. Using a user interface the users can submit their queries in various formats, including text and audio. Once a user query 112 is received, the system processes the input using natural language processing and keyword recognition techniques to interpret the user's intent. This processing allows the LLM 110 to accurately identify the context and content of the query, enhancing the quality of the generated response. This process can be the same or substantially similar to any natural language processing techniques that are discussed herein above.

In an embodiment, the chatbot system 400 can employ decision trees to enhance the chatbot's capability to provide tailored query responses 120. After receiving the input data, processor 102 can utilize a decision tree structure to analyze the data. This structure allows the system to map out various pathways to a solution based on user queries 112. Each node in the decision tree can correspond to user actions, problem-solving methodologies, and the like. As the user navigates through these options, the chatbot system 400 can progressively refine its understanding of the user's needs, ensuring that the eventual query response 120 is aligned with the specific context established by the query context data 114.

Additionally, the LLM 110 can incorporate feedback from the decision tree to enhance the chatbot's responses. By leveraging historical interaction data and user profiles, the decision tree can guide the LLM 110 in selecting the most appropriate response pathways. For instance, if a user frequently asks about equipment maintenance, the decision tree can prioritize relevant content clusters 116 related to that topic. As the user engages with the chatbot system 400, the LLM 110 can use these pathways to generate structured responses that draw on both the workflow data structure 118 and the enriched context from prior interactions.

With continued reference to FIG. 1, query responses 120 can be grounded using a grounding process. As used in the current disclosure, a grounding process refers to a process by which a machine-learning model, such as LLM 110, ensures that its response to a query is grounded in real-world data. The grounding process can be used to validate query responses 120 that are produced by the LLM 110. This process involves leveraging the corpus of documents 106 to validate and substantiate the output of the LLM 110.

The grounding process can include a data-driven methodology where the generated query responses 120 is cross-referenced with the corpus of documents 106. This can include identifying and extracting real-world information associated with the relevant content clusters 116 or segment of document that was referenced in the query response 120. The grounding process includes a comparison of this real-world information against those generated in the original query response 120. This comparative analysis is designed to highlight any discrepancies between information within the query response 120 and the information that was sourced from the corpus of documents 106. In situations where query response 120 diverges from the real-world data, the grounding process prioritizes the more accurate, externally sourced information, ensuring that the final output is grounded in validated data. Any ungrounded or inaccurate information identified during the comparative analysis can be filtered out from the response. This filtration step can include flagging, modifying, or eliminating entries within the workflow data structure 118 to ensure that only grounded information remains.

In some cases, the filtration step can include identifying, modifying, or eliminating correlations or training examples within the training data that are inaccurate. For instance, if the training data, which suggests a particular relationship between certain variables, is contradicted by the comparative analysis of the grounding process, the grounding process will prioritize the real-world values. This is done to improve and correct the LLM's 110 understanding.

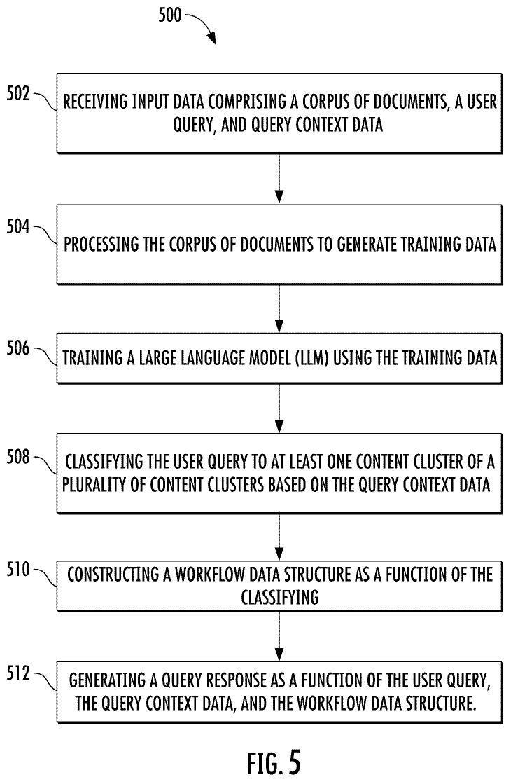

Referring now to FIG. 5, an exemplary flow diagram for a method for generating a workflow data structure.

At step 502, the method includes receiving, by one or more processors, input data including a corpus of documents, a user query, and query context data. In an embodiment, the method can further include processing, by the one or more processors, the user query, and the query context data to generate a smart prompt. In some cases, wherein the query context data can include a user profile.

In some cases, the method further includes generating, by the LLM, one or more contextual inquiries based on the user query and the query context data; receiving, by the LLM, a second user query from a user based on the one or more contextual inquiries; and updating, by the LLM, the query context data based on the second user query.

In an embodiment, the corpus of documents can be a collection of materials that are related to the functional processes of an entity. The corpus of documents may include internal and external reports, emails, instruction manuals, repair manuals, maintenance history, repair history, performance history, activity logs, and the like. For example, the emails can be used to provide insight into communication and decision-making among personnel and stakeholders.

At step 504, the method includes processing, by the one or more processors, the corpus of documents to generate training data. In an embodiment, processing the corpus of documents can include segmenting the corpus of documents into a plurality of segments based on a semantic pattern; and producing one or more embeddings for each segment of the plurality of segments; and generating the training data based on the one or more embeddings. In some cases, processing the corpus of documents can further include classifying the one or more embeddings to at least one content cluster of the plurality of content clusters.

Processing the corpus of documents can include digitizing and organizing the corpus of documents. This can include extracting relevant information and structuring it into a format suitable for training the LLM. Information can be extracted from the corpus of documents by categorizing, clustering, or classifying segments of the documents into a structure that aligns with the requirements of the LLM. In some cases, the training data can include generating exemplary question-and-answer pairs based on key insights found in the corpus of documents or summarizing lengthy documents into concise vectors that can represent the semantic meaning of the text.

At step 506, the method includes training a large language model (LLM) using the training data. The LLM can include an artificial intelligence system designed to understand and generate human-like text based on the training data generated from the corpus of documents. The LLM can leverage deep learning techniques to analyze patterns in language, allowing them to generate coherent and contextually relevant responses. In an embodiment, the LLM can be generally to provide the model with a foundational understanding of language. In an embodiment, the LLM may include a machine-learning model, RAG, and the like.

In an embodiment, the training process for the LLM can include two phases: general training and specific training. During general training, the LLM gains a foundational understanding of language based on its training using diverse datasets. Once pretrained, the model can undergo specific training using the custom dataset that was generated from the corpus of documents. Specific training can include supervised learning, where the LLM is trained on labeled examples that help it refine its responses to meet the needs of specific tasks.

At step 508, the method includes classifying, using the LLM operating on the one or more processors, the user query to at least one content cluster of a plurality of content clusters based on the query context data.

Classifying the user query to at least one content cluster of a plurality of content clusters can include using one or more natural language processing techniques to identify key words and phrases within the user query. These key words may be compared against a predefined set of content clusters, wherein each content cluster represents a distinct subject matter. The LLM may evaluate which content cluster aligns best with the user's query based on a semantic analysis. Once a suitable match is identified, the LLM links the user query to the relevant content cluster.

In some embodiment, The LLM can classify portions of the corpus of documents into respective content clusters using the same or substantially similar process for categorizing the user query. As the LLM processes each document, it can use the labeled training data associated with the corpus of documents to organize the corpus of documents into the appropriate clusters.

At step 510, the method includes constructing, using the LLM, a workflow data structure as a function of the classifying. The workflow data structure is used to capture and optimize the relationship between the user queries and content clusters. The workflow data structure can include metadata for labeling and tagging content clusters. This tagging process can be used to create correlations between the user queries and content clusters based on their contextual relevance to one another. Additionally, based on these correlations the LLM can generate predefined response templates to facilitate efficient query responses.

At step 512, the method includes generating, using the LLM, a query response as a function of the user query, the query context data, and the workflow data structure. In an embodiment, generating the query response can include generating a workflow report based on the workflow data structure. In an additional embodiment, the method can further include grounding, by the one or more processors, the query response as a function of the corpus of documents using a grounding process.

In a non-limiting example, assume the computing device receives user query such as “When is the next time Machine A should be serviced?” To analyze the user query, the LLM can classify the user query into a content cluster focused on Machine A's maintenance. After classifying the query, the LLM interacts with the workflow data structure to access known training examples concerning Machine A's service history. In an embodiment, the workforce data structure might contain information about protocols for maintenance, historical service intervals, and best practices derived from past repairs. Based on this information, the LLM generates a query response that might state, “Machine A was last serviced on Jan. 7, 2024, and is due for service every six months or 4000 machine hours.”

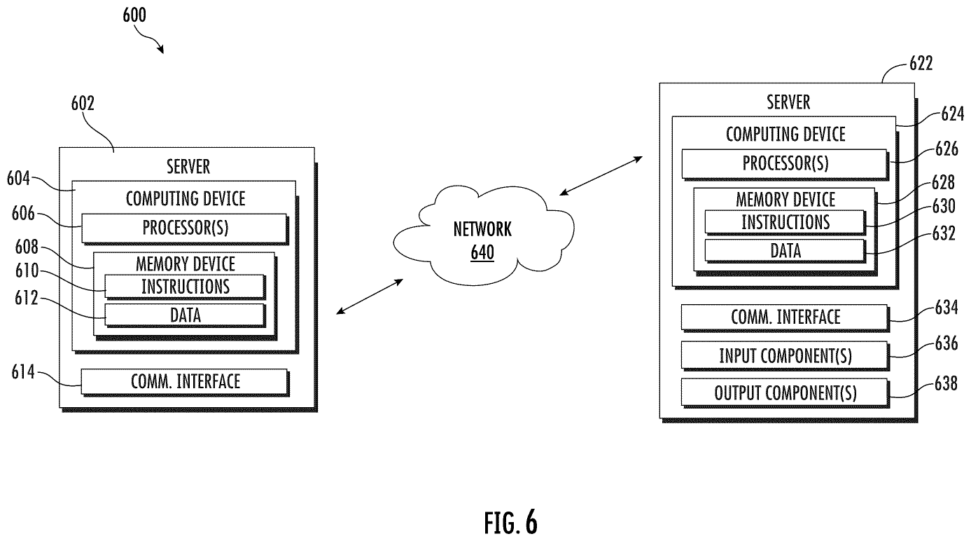

FIG. 6 depicts an example computing system 600 that can be used to implement the systems and methods for generating a workflow data structure according to example embodiments of the present disclosure. The system 600 can be implemented using a client-server architecture that includes one or more servers 602 and a user device 622 which can act as a client of one or more of the servers 602. For example, servers 602 can include one or more cloud computing devices, one or more remote memory devices, and/or the like. For example, user device 622 can include a personal communication device, a smartphone, desktop computer, laptop, mobile device, tablet, wearable computing device, and/or the like.

Each of the servers 602 and user device 622 can include at least one computing device, such as depicted by server computing device 604 and user computing device 624. Although only one server computing device 604 and one user computing device 624 are illustrated in FIG. 6, multiple computing devices optionally can be provided at one or more locations for operation in sequential configurations or parallel configurations to implement the disclosed methods and systems. In other examples, the system 600 can be implemented using other suitable architectures, such as a single computing device.

Each of the computing devices 604, 624 in system 600 can be any suitable type of computing device. For example, computing devices 604, 624 can include a general-purpose computer, special purpose computer, and/or other suitable computing device. Computing device 624 can include, for instance, location resources, a GPS, and/or other suitable device.

The computing devices 604 and/or 624 can respectively include one or more processor(s) 606, 626 and one or more memory devices 608, 628. The one or more processor(s) 606, 626 can include any suitable processing device, such as a microprocessor, microcontroller, integrated circuit, logic device, one or more central processing units (CPUs), graphics processing units (GPUs) dedicated to efficiently rendering images or performing other specialized calculations, and/or other processing devices. The one or more memory devices 608, 628 can include one or more computer-readable media, including, but not limited to, non-transitory computer-readable media, RAM, ROM, hard drives, flash drives, or other memory devices. In some examples, memory devices 608, 628 can correspond to coordinated databases that are split over multiple locations.

The one or more memory devices 608, 628 can store information accessible by the one or more processors 606, 626, including instructions 610, 630 that can be executed by the one or more processors 606, 626. For instance, server memory device 608 can store instructions for pairing one or more smart devices as disclosed herein. The user memory device 628 can store instructions for implementing a user interface that allows a user to visualize and interact with an environment including a plurality of smart devices.

The one or more memory devices 608, 628 can also include data 612, 632 that can be retrieved, manipulated, created, or stored by the one or more processors 606, 626. The data 612 stored at server 602 can include, for instance, device data such as, for example, device attributes, communication data, etc. associated with each respective device of a plurality of smart devices. The data 632 stored at user device 622 can include, for example, image data, device data, etc. Data 612 and data 632 can include the same, similar, and/or different data.

Computing devices 604 and 624 can communicate with one another over a network 640. In such instances, the server 602 and the user device 622 can also respectively include a network interface (e.g., communication interface 614 and 634, respectively) used to communicate with one another over network 640. The network interface(s) can include any suitable components for interfacing with one more networks, including for example, transmitters, receivers, ports, controllers, antennas, or other suitable components. The network 640 can be any type of communications network, such as a local area network (e.g. intranet), wide area network (e.g. Internet), cellular network, or some combination thereof. The network 640 can also include a direct connection between server computing device 604 and user computing device 624. In general, communication between the server computing device 604 and user computing device 624 can be carried via the network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

User device 622 can include various input/output devices for providing and receiving information to/from a user. For instance, an input device 636 can include devices such as a touch screen, touch pad, data entry keys, and/or a microphone suitable for voice recognition. An output device 638 can include audio or visual outputs such as speakers or displays for providing, for instance, graphical user interfaces as described herein.

The technology discussed herein makes reference to servers, databases, software applications, and other computer-based systems, as well as actions taken, and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel. Furthermore, computing tasks discussed herein as being performed at a server can instead be performed at a user device. Likewise, computing tasks discussed herein as being performed at the user device can instead be performed at the server.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal language of the claims.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for generating a workflow data structure, comprising:
one or more processors; and
one or more non-transitory computer-readable media storing instructions that are executable to cause the one or more processors to perform operations, the operations comprising:
receiving input data comprising a user query and query context data;
classifying, using a large language model (LLM), the user query to at least one content cluster of a plurality of content clusters based on the query context data;
constructing, using the LLM, a workflow data structure as a function of the classifying; and
generating, using the LLM, a query response as a function of the user query, the query context data, and the workflow data structure.

2. The computing system of claim 1, wherein the operations further comprise:
receiving a corpus of documents;
processing the corpus of documents to generate training data, wherein processing the corpus of documents comprises:
segmenting the corpus of documents into a plurality of segments based on a semantic pattern; and
producing one or more embeddings for each segment of the plurality of segments; and
generating the training data based on the one or more embeddings; and
training the LLM using the training data.

3. The computing system of claim 2, wherein processing the corpus of documents further comprises classifying the one or more embeddings to at least one content cluster of the plurality of content clusters.

4. The computing system of claim 1, wherein generating the query response comprises generating a workflow report based on the workflow data structure.

5. The computing system of claim 1, wherein the operations further comprise grounding the query response as a function of a corpus of documents using a grounding process.

6. The computing system of claim 1, wherein the operations further comprise processing the user query and the query context data to generate a smart prompt.

7. The computing system of claim 1, wherein the query context data comprises a user profile.

8. The computing system of claim 1, wherein the operations further comprise:
generating one or more contextual inquiries based on the user query and the query context data;
receiving a second user query from a user based on the one or more contextual inquiries; and
updating the query context data based on the second user query.

9. A method for generating a workflow data structure, comprising:
receiving, by one or more processors, input data comprising a corpus of documents, a user query, and query context data;
processing, by the one or more processors, the corpus of documents to generate training data;
training a large language model (LLM) using the training data;
classifying, using the LLM operating on the one or more processors, the user query to at least one content cluster of a plurality of content clusters based on the query context data;
constructing, using the LLM, a workflow data structure as a function of the classifying; and
generating, using the LLM, a query response as a function of the user query, the query context data, and the workflow data structure.

10. The method of claim 9, wherein processing the corpus of documents comprises:
segmenting the corpus of documents into a plurality of segments based on a semantic pattern; and
producing one or more embeddings for each segment of the plurality of segments; and
generating the training data based on the one or more embeddings.

11. The method of claim 10, wherein processing the corpus of documents further comprises classifying the one or more embeddings to at least one content cluster of the plurality of content clusters.

12. The method of claim 9, wherein generating the query response comprises generating a workflow report based on the workflow data structure.

13. The method of claim 9, wherein the method further comprises grounding, by the one or more processors, the query response as a function of the corpus of documents using a grounding process.

14. The method of claim 9, wherein the method further comprises processing, by the one or more processors, the user query and the query context data to generate a smart prompt.

15. The method of claim 9, wherein the query context data comprises a user profile.

16. The method of claim 9, wherein the method further comprises:
generating, by the LLM, one or more contextual inquiries based on the user query and the query context data;
receiving, by the LLM, a second user query from a user based on the one or more contextual inquiries; and
updating, by the LLM, the query context data based on the second user query.

17. A computing system for generating a workflow data structure, comprising:
one or more processors; and
one or more transitory or non-transitory computer-readable media storing instructions that are executable to cause the one or more processors to perform operations, the operations comprising:
receiving input data comprising a corpus of documents;
processing the corpus of documents to generate training data, wherein processing the corpus of documents comprises:
segmenting the corpus of documents into a plurality of segments based on a semantic pattern;
producing one or more embeddings for each segment of the plurality of segments; and
generating the training data based on the one or more embeddings; and
training a large language model (LLM) using the training data.

18. The computing system of claim 17, wherein training the LLM further comprises specifically training the LLM using the training data.

19. The computing system of claim 17, wherein the operations further comprise:
receiving a user query and query context data;
classifying, using the LLM, the user query to at least one content cluster of a plurality of content clusters based on the query context data;
constructing, using the LLM, a workflow data structure as a function of the classifying; and
generating, using the LLM, a query response as a function of the user query, the query context data, and the workflow data structure.

20. The computing system of claim 19, wherein the operations further comprise:
generating one or more contextual inquiries based on the user query and the query context data;
receiving a second user query from a user based on the one or more contextual inquiries; and
updating the query context data based on the second user query.
